(19) United States
(12) Patent Application Publication
(10) Pub. No.: US 2010/0248936 A1
(43) Pub. Date: Sep. 30, 2010

(54) Calcined ceramic body for dental use

(75) Inventors: Yoshihisa Yamada, Miyoshi (JP); Atsushi Matsumoto, Miyoshi (JP)

Correspondence Address: OLIFF & BERRIDGE, PLC, P.O. BOX 320850, ALEXANDRIA, VA, 22320-4850, US

(73) Assignee: NORITAKE CO., LIMITED, Nagoya (JP)

(21) Appl. No.: 12/659,723

(22) Filed: Mar. 18, 2010

(30) Foreign Application Priority Data
Mar. 23, 2009 (JP) 2009-070989

(51) Int. Cl. C04B 35/48

(52) U.S. Cl. 501/134

(57) ABSTRACT

It is provided a calcined ceramic body for dental use that is manufactured such that a formed body mainly containing zirconium oxide is worked in a degreasing process and in a calcining process, having a linear contraction coefficient upon full burning ranging from 19.0% to 22.0%.

This application is based on Japanese Patent Application No. 2009-070989 filed on Mar. 23, 2009, the contents of which are incorporated hereinto by reference.

### BACKGROUND OF THE INVENTION

1. Field of the Invention

The present invention relates to a calcined ceramic body for dental use that is used for such as a frame of an artificial tooth.

2. Description of Related Art

The conventional dental prosthesis fit in an oral cavity is made by coating a surface of a metal frame with a ceramic material (porcelain material) of which the color tone is adjusted to have a similar color to a natural tooth. And recently the all-ceramic prosthesis in which the whole prosthesis is made of ceramic material is used. For such an all-ceramic prosthesis, for instance, a frame made of a sintered ceramic body instead of the conventional metal frame is used, and an outer portion (that is, a ceramic layer) is formed by using glass porcelain material on the surface of the frame. The conventional prosthesis raises problems such as that the living body suffers from metal allergy due to contact to metal or that the original color tone like the natural tooth cannot obtained due to a nontransparent backing layer that is formed for hiding a metal color. All-ceramic prosthesis advantageously solves or soften the problems.

The aforementioned ceramic frame is manufactured from, in general, zirconia (zirconium oxide) as a main raw material by using CAD/CAM working. There are three sorts of methods as (1) a method to work by cutting a sintered body, (2) a method to work by cutting a pre-burnt formed body and burnt, and (3) a method to work by cutting a calcined body and burnt.

In the aforementioned first method, the sintered body sintered at about 1300 to 1600° C. or worked in hot isostatic pressing (HIP) is worked by cutting. It is an advantage that the accurate frame in dimensions can be manufactured in dependence on accuracy provided by measuring instruments and processing machines, due to the absence of changes in dimensions after cutting works. On the contrary, it disadvantageously provides long working time for cutting due to its high hardness and high cost for manufacturing due to short life span of tools such as drills.

In the aforementioned second method, cutting works are performed in consideration for the contraction coefficient upon burning, and the burning process is performed at 1300 to 1600° C. The accurate frame in dimensions can be manufactured as well as the first method because the constant contraction coefficient can continue by controlling the forming condition and the density of the formed body. On the contrary, it disadvantageously provides long time, for instance, ten hours, for the burning process because it includes the degreasing step.

On the contrary, in the aforementioned third method, cutting works are performed in consideration for the contraction coefficient upon full burning calculated from the contraction coefficient upon calcining, and the burning process is performed at 1300 to 1600° C. It advantageously provides the long life span of tools due to short working time for cutting due to its lower hardness than the sintered body, and the short burning time after cutting because degreasing is completed. Accordingly, most of frames are manufactured in the third method, very little frames are manufactured in the second method and almost none of frames are manufactured in the first method today.

However, it was required to individually measure the contraction coefficient of the calcined body before cutting works because the conventional calcined body had an unstable contraction coefficient upon calcining, and it required extreme labor. Furthermore, it was difficult to obtain high accuracy in dimensions because the contraction coefficient varied with the parts within one calcined body, due to the dispersion in the temperature in the kiln. In result, it was a disadvantage that conformity of the dental crown and the abutment that the dental crown was fit to was difficult to be obtained. Problems occur by that the frame cannot be fit to or is too loose on the abutment if, for instance, the difference between the actual linear contraction coefficient and the estimated value is equal to or more than 0.5%.

Various improvements of the aforementioned calcined body have been suggested. For instance, JP 2003-506191 A discloses a calcined body having 15 to 30 MPa strength and is superior in workability. U.S. Pat. No. 6,354,836 discloses a calcined body having 10 to 13% contraction coefficient. JP 2008-055183 A discloses about 31 to 50 MPa flexural strength of a calcined body. WO 2008/148494 A discloses 53 to 74 MPa, high flexural strength of a calcined body. This discloses that the range of the strength is unexpectedly preferable for working, by overcoming the tendency of being damaged upon cutting works with the calcined body having the low strength disclosed in the aforementioned JP 2003-506191 A or JP 2008-055183 A, and by overcoming incapability to work by the normal machinery due to the high strength.

JP 2007-314536 A discloses a colored calcined body obtained by pressure forming of oxide powder coated with coloring material and by preliminary sintering (calcining).

JP 2000-203949 A discloses a calcined formed body that is calcined at 20 to 30% lower temperature than the burning temperature, to increase the material strength and, accordingly, to increase quality of cutting and handling, although not relating to dental material.

Although such various improvements in such as workability of the calcined body have been suggested as described above, no improvement relates to the dispersion of the contraction coefficient.

It is therefore an object of the present invention to provide a calcined ceramic body for dental use that is stable in the contraction coefficient.

### SUMMARY OF THE INVENTION

The object indicated above may be achieved according to a first mode of the invention, which provides a calcined ceramic body for dental use that is manufactured such that a formed body mainly containing zirconium oxide is worked in a degreasing process and in a calcining process, characterized by having a linear contraction coefficient upon full burning ranging from 19.0% to 22.0%.

The object indicated above may be achieved according to a second mode of the invention, which provides a calcined ceramic body for dental use that is manufactured such that a formed body mainly containing zirconium oxide is worked in a degreasing process and in a calcining process, characterized by having a density ranging from 47% to 49% of a theoretical density of a sintered body.

Since, according to the first mode of the invention, the linear contraction coefficient upon full burning ranges from 19.0% to 22.0%, an extremely large value, and the contraction upon the calcination stage is limited to an extremely small value, the dispersion of the linear contraction coefficient of each calcined body and the dispersion in the linear contraction coefficient of the individual calcined body varied in dependence on its position are extremely reduced. Consequently, the calcined ceramic body for dental use that is stable in the linear contraction coefficient can be obtained. The linear contraction coefficient is determined in the following Equation (1). The linear contraction coefficient of zirconia ceramics from a formed body is, for instance, 22% and a little bit over, and, accordingly, the aforementioned upper limit value means that the contraction by calcination does not almost proceed.

Linear Contraction Coefficient=(Dimension Before Calcined−Dimension After Calcined)/Dimension Before Calcined×100 Equation (1)

Since, according to the second mode of the invention, the density of the calcined body ranges from 47% to 49% of the theoretical density of a sintered body, an extremely small value, and the contraction upon the calcination stage is limited to an extremely small value, the dispersion of the linear contraction coefficient of each calcined body and the dispersion in the linear contraction coefficient of the individual calcined body varied in dependence on its position are extremely reduced. Consequently, the calcined ceramic body for dental use that is stable in the linear contraction coefficient can be obtained.

Preferably, according to the third mode of the invention, it is characterized by that the calcined ceramic body for dental use of the first or second mode of the invention, has a three-point bending strength ranging from 3 to 6 MPa. This provides the calcined body that is facilitative to handle and work.

Preferably, according to the fourth mode of the invention, it is characterized by that the calcined ceramic body for dental use of the first or second mode of the invention, of which a calcination temperature ranges from 800° C. to 950° C. The aforementioned linear contraction coefficient, the aforementioned density and the aforementioned flexural strength can be facilitatively obtained by calcining in the aforementioned range of the temperature. Since zirconia ceramics tends to rapidly contract from, for instance, about 1000° C., it is preferable to set the calcination temperature at 950° C. or below. Since the strength can be obtained after the binding of the granules of the material proceeds in a degree, the temperature of 800° C. or over is preferable.

Preferably, according to the fifth mode of the invention, it is characterized by that the calcined ceramic body for dental use of any of the first to fourth modes of the invention, which includes 91.00 to 98.45 wt % zirconium oxide, 1.5 to 6.0 wt % yttrium oxide, and 0.05 to 0.50 wt % oxide or oxides of at least one of aluminum, gallium, germanium and indium. The composition of zirconia constitutes the calcined body according to the present invention is not especially limited, for instance, as well as yttrium oxide, such as cerium oxide, calcium oxide or magnesium oxide is used as a stabilizer, and the aforementioned composition is preferable in consideration for such as strength and a color tone.

Preferably, the calcined ceramic body for dental use of any of the first to fifth modes of the invention, which includes a pigment. This can provide the artificial tooth having a color tone that is similar to a natural tooth even if it is difficult with an original tone of zirconium oxide. The transition metal oxide of the IV to VI groups, aluminum compound, silicon compound, iron oxide, magnesium oxide, nickel oxide, iron sulfide, magnesium sulfide, nickel sulfide, nickel acetate, iron acetate or magnesium acetate can be used as a pigment. The pigment can be, for instance, concurrently added upon granulation by adding an organic binder to zirconia material. And, upon the granulation, a sintering aid may be added if necessary.

In any of the first to fifth modes of the invention, the forming method to obtain the aforementioned calcined body is not especially limited, and any of proper conventional methods for forming ceramics such as powder pressing, injection molding or inshot molding, may be used. The evenness in the forming density can be improved and, then, it causes to improve the formed body in evenness in the density, to provide the further stable linear contraction coefficient, by the cold isostatic pressing (CIP) forming if necessary.

In any of the first to fifth modes of the invention, the calcined body according to the present invention and an artificial tooth using the same is, for instance, manufactured in the following process. First, zirconia material granules are prepared and formed by pressing. Next, the formed body is processed by the CIP forming if necessary. The pressure upon it is, for instance, 100 to 500 MPa. Next, the calcination step is processed. In the calcination step, it is gently raised from the room temperature to the range from 800 to 950° C. and the formed body is moored for about one to six hours, to provide the linear contraction coefficient of, for instance, about 0.2 to 1.0% on the basis of the formed body and the flexural strength of about 3 to 6 MPa after calcined. This causes to provide a calcined ceramic body for dental use of which the above-described dispersion of contraction is reduced.

The artificial tooth is manufactured, for instance, with the aforementioned formed body by a dental technician or in a dental laboratory, in the following steps. First, the frame drawings are prepared in a predetermined proportion that is determined for each calcined body, by using CAD, in accordance with a model provided by a dentist. The predetermined “proportion” is an enlargement ratio calculated from the specific linear contraction coefficient of the calcined body, and the dimensions of the respective portions can be obtained by multiplying the dimension of the model by the proportion. Next, a frame calcined body is obtained by cutting from the calcined body by using CAM. Next, the obtained frame calcined body is processed in full burning. In this step it is moored for about 30 minutes to two hours at the temperature about from 1300 to 1600° C. Next, a porcelain material is piled on the surface of the sintered frame. This causes to obtain an artificial tooth of the same shape as the model.

### BRIEF DESCRIPTION OF THE DRAWINGS

FIG. 1 illustrates a calcined block for dental use in the shape of a disk according to one embodiment of the present invention.

FIG. 2 illustrates the sectional structure of a frame cut from the calcined block in FIG. 1.

FIG. 3 illustrates the process explaining the methods for manufacturing and using the calcined block in FIG. 1.

FIG. 4 is a graph depicting the relationship between the calcination temperature and the linear contraction coefficient of the calcined block in FIG. 1.

### DETAILED DESCRIPTION OF EXEMPLARY EMBODIMENTS

Hereinafter, there will be described the present invention by reference to the drawings. The figures are appropriately simplified or transformed, and all the proportion of the dimension and the shape of a portion or member may not be reflective of the real one in the following embodiments.

### Embodiment 1

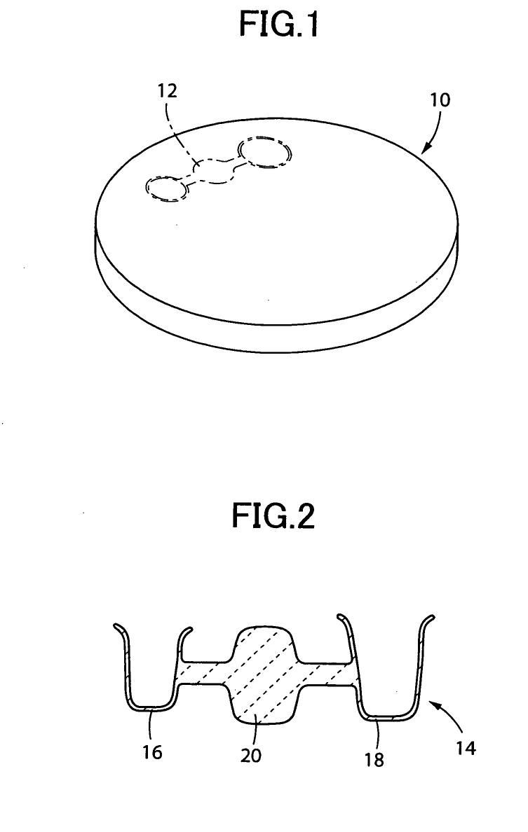

FIG. 1 illustrates a calcined block 10 for dental use in the shape of a disk in a perspective view. The calcined block 10 is, for instance, made of zirconia ceramics (TZP) containing zirconium oxide and 3 mol % yttrium oxide as a stabilizer. It is a calcined body prepared by degreasing and calcining at the low temperature from a formed body as described below. The calcined block 10 is about 94 mm in diameter and about 14 mm in thickness.

The aforementioned calcined block 10 is used for a frame of a prosthesis that is wholly made of ceramic such as a bridge or a crown. FIG. 1 illustrates an example of the frame to be machined defined by dotted and dashed lines 12, and FIG. 2 illustrates an example of the machined frame 14 in the sectional view. In FIG. 2 the frame 14 is used for a three-tooth bridge that is prosthetics compensating one molar of the adult. It includes core elements (that is, frames of the coping portions) 16, 18 corresponding to abutments, and a core element (that is, a frame of the pontic portion) 20 corresponding to the missing tooth connected to the respective core elements 16, 18.

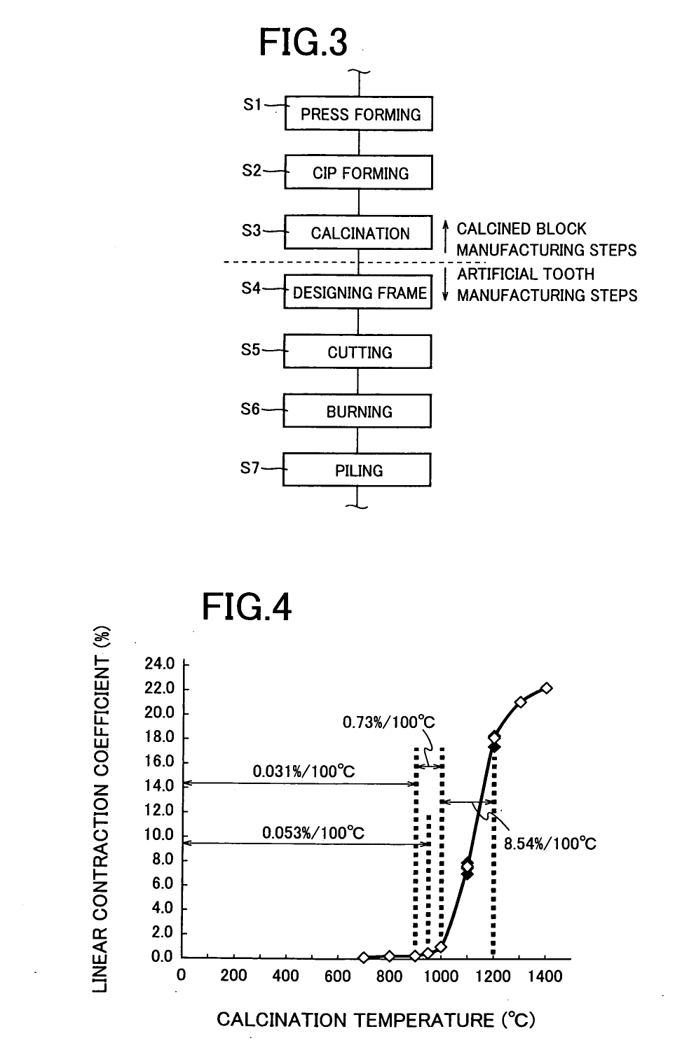

FIG. 3 illustrates the process explaining the essential of the methods for manufacturing the aforementioned calcined block 10 and the artificial tooth using it. Zirconia granules are prepared by manufacturing in a proper compound method and a granulating method, and formed to be a disk by a single shaft press in the press forming step S1. The Zirconia granules include a polymeric organic binder and/or placticizer, and, in addition, they may include a coloring agent.

Next, in the CIP forming step S2 the disk-shaped formed body obtained is processed to be formed in a pressure of about, for instance, 100 to 500 MPa in the CIP forming. This step is performed in order to improve in evenness in quality of the formed body. If the press forming achieves sufficient evenness in quality, this step is not requisite.

Next, in the calcining step S3 the aforementioned formed body (namely, the raw block) is calcined. In this step in which the temperature is raised to a certain value in the range from 800 to 950° C., the formed body is moored for about one to six hours. During raising of the temperature the resin binding agent (binder) included in the granules is removed in burning, and, furthermore, the aforementioned calcined block 10 is obtained as a result of mutual binding of the granules. The set of the press forming step S1 to the calcining step S3 corresponds to the manufacturing step of the calcined block 10. The linear contraction coefficient from the formed body is, for instance, 0.2 to 1.0%, and the density of the calcined block 10 is 2.90 to 2.92 g/cm². The density of the calcined block 10 is about 47.6 to 48.0% of the theoretical density of the sintered body, 6.089 g/cm². The flexural strength by the three-point bending test is about 3 to 6 MPa and it is low in strength, however, it is entirely sufficient strength upon machining such as cutting of the frame and handling the formed body in the steps until burning.

The following steps are performed by a dental technician or in a dental laboratory, and performed for each patient to be equipped with the artificial tooth. In the frame designing step S4 the frame is designed in a predetermined proportion that is determined for each calcined block 10, by using CAD, in accordance with a model provided by a dentist.

Next, in the cutting step S5, in accordance with the aforementioned design, a frame calcined body is cut from the calcined block 10 by using CAM. Since the calcined block 10 has a sufficient strength as described above, no problems arise, for instance, a damage upon or after cutting-away.

Next, in the burning step S6 the frame calcined body that is cut away is processed in burning. In this step in which the temperature is raised to a certain value in the range from 1300 to 1600° C., the frame calcined body is moored for about 30 minutes to two hours. This causes the zirconia material to be sintered to obtain the aforementioned frame 14. The aforementioned mooring temperature is determined in dependence upon the zirconia granules. The linear contraction coefficient is upon sintering from the calcined block (that is, upon full burning) is in the range from 19.0 to 22.0%; for instance, about 21%.

Next, in the piling step S7, a porcelain material is piled on the aforementioned frame 14. For instance, a slurry prepared by dispersing a ceramic powder in such as a propylene glycol solution is applied onto the frame 14, and it is burnt, for example, at a temperature of about 930° C. to form a ceramic layer. This step is repeated requisite times to obtain a desired artificial tooth.

Then, according to the present embodiment, since the linear contraction coefficient upon full burning ranges from 19.0 to 22.0%, that is, extremely large and the contraction in the calcining stage is reduced to 0.2 to 1.0%, that is, a extremely small value, the dispersion in the linear contraction coefficient of each calcined body block 10 and the dispersion in the linear contraction coefficient of the individual calcined body block 10 varied in dependence on its position are extremely reduced. That is, the calcined ceramic body block 10 for dental use having the stable linear contraction coefficient can be obtained. Accordingly, the artificial tooth having small differences in dimensions in comparison with the provided model, and of which the dental crown highly conforms with the abutment, can be obtained.

According to the present embodiment, since the density of the calcined block 10 is about 47.6 to 48.0%, that is, extremely small, of the theoretical density of the sintered body and the contraction in the calcining stage is reduced to 0.2 to 1.0%, that is, the extremely small value as described above, the dispersion in the linear contraction coefficient of each calcined block 10 and the dispersion in the linear contraction coefficient of the individual calcined block 10 varied in dependence on its position are extremely reduced advantageously.

According to the present embodiment, since the calcination temperature of the calcined block 10 ranges from 800 to 950° C., the aforementioned linear contraction coefficient, density and flexural strength are achieved.

In the present embodiment, the calcination temperature was determined on the basis of the tests shown below in order to obtain the aforementioned values of the linear contraction coefficient. Table 1 below shows the relationship of the calcination temperature, flexural strength of the calcined body, linear contraction coefficient, density and theoretical density ratio. For this test samples were prepared in the same conditions as in the case of the disk-shaped block, other than using a different-shaping prism block (that is, a test piece of the shape of a prism) of the dimensions of 77×23×18 mm, and determining the mooring time upon calcining as one hour. In Table 1 below, the flexural strength was measured in the three-point bending test, and the linear contraction coefficient was measured in each of the length, width and thickness directions. The calcination density was determined by the volume and the mass calculated on the basis of the dimensions of the samples, and the theoretical density ratio was determined by dividing it by the theoretical density 6.089 g/cm³ of the zirconia sintered body.

TABLE 1
Prism Block (Moored for one hour)

| | Calcination Temperature (° C.) | | | | | | | | |
|---|---|---|---|---|---|---|---|---|---|
| | 700 | 800 | 900 | 950 | 1000 | 1100 | 1200 | 1300 | 1400 |
| Flexural Strength (MPa) | 2.32 | 3.62 | 3.57 | 4.78 | 10.12 | 26.61 | | | |
| | 2.31 | 3.45 | 3.90 | 6.19 | 20.30 | 29.69 | | | |
| | 2.75 | | 5.32 | 5.38 | 21.10 | 27.69 | | | |
| | | | 5.42 | | | | | | |
| | | | 4.70 | | | | | | |
| Average | 2.46 | 3.54 | 4.58 | 5.45 | 17.17 | 28.00 | | | |

Linear Contraction Coefficient (%)

| | | | | | | | | |
|---|---|---|---|---|---|---|---|---|
| Sample 1 | Length | 0.13 | 0.24 | 0.31 | 0.47 | 1.05 | 7.48 | 18.27 |
| | Width | 0.11 | | 0.25 | 0.51 | 0.93 | 7.43 | 18.36 |
| | Thickness | 0.11 | | 0.22 | 0.43 | 0.93 | 6.98 | 18.04 |
| Sample 2 | Length | | 0.26 | 0.30 | 0.52 | 1.10 | 7.87 | 17.98 |
| | Width | | | 0.30 | 0.52 | 1.02 | 7.98 | 18.14 |
| | Thickness | | | 0.28 | 0.53 | 0.90 | 7.40 | 17.37 |
| Sample 3 | Length | | 0.24 | 0.28 | 0.53 | 1.03 | 7.91 | 18.35 |
| | Width | | | 0.30 | 0.51 | 1.10 | 7.89 | 18.27 |
| | Thickness | | | 0.26 | 0.44 | 1.04 | 7.43 | 17.95 |

| | | | | | | | | | |
|---|---|---|---|---|---|---|---|---|---|
| Total Average | 0.12 | 0.25 | 0.28 | 0.50 | 1.01 | 7.60 | 18.08 | 21.05 | 22.21 |
| Calcination Density(g/cm³) | — | 2.900 | 2.915 | 2.920 | 2.983 | 3.632 | | | 6.040 |
| Theoretical Density Ratio (%) | — | 47.6 | 47.9 | 48.0 | 49.0 | 59.6 | | | 99.2 |

In Table 1 above, in the case of the calcination temperature of 800° C., the flexural strength ranges from 3.45 to 3.62 MPa and 3.54 MPa in average and the linear contraction coefficient ranges from 0.24 to 0.26% and 0.25% in average, in the case of 900° C., the flexural strength ranges from 3.57 to 5.42 MPa and 4.58 MPa in average and the linear contraction coefficient ranges from 0.22 to 0.31% and 0.28% in average, and in the case of 950° C., the flexural strength ranges from 4.78 to 6.19 MPa and 5.45 MPa in average and the linear contraction coefficient ranges from 0.43 to 0.53% and 0.50% in average. The flexural strength of 3 MPa or over is sufficient for cutting and, in the case of 800° C. or over, it meets the requirement. In the case of the linear contraction coefficient of 1% or below, the dispersion of contraction upon the full burning of the calcined block shows extremely small value below 0.5%, and, accordingly, the artificial tooth of which the dental crown highly conforms with the abutment can be obtained.

On the other hand, in the case of the calcination temperature of 700° C., the linear contraction coefficient is a small value and ranges from 0.11 to 0.13% and 0.12% in average, and, accordingly, the dispersion of contraction from the calcined block, however, the flexural strength ranges only from 2.31 to 2.75 MPa and 2.46 MPa in average, and, consequently, it is difficult to machine due to insufficiency in strength. In the case of the calcination temperature of 1000° C., the linear contraction coefficient ranges from 0.90 to 1.10% and up to 1.01% in average, and, accordingly, the dispersion of contraction upon the full burning of the calcined block shows a value of 0.5% or over, and, accordingly, the frame having high accuracy in dimensions cannot be obtained. Problems occur by such as nonconformity of the dental crown and abutment, and difficulty or excessive looseness to fit the frame. Since the flexural strength increases as the calcination temperature increases, in the case of 1000° C. or over, it has sufficient strength to bear machining. However, since the dispersion of contraction increases with progression of contraction, the accuracy in dimensions reduces.

FIG. 4 is a graph depicting the relationship between the calcination temperature and the linear contraction coefficient. The contraction does not almost progress below about 900° C. and the linear contraction coefficient does not almost change when the temperature changes. It is only about 0.031%/100° C. in average. However, the contraction apparently progresses over 900° C., the change in the contraction coefficient to the change in temperature increases to about 0.73%/100° C. The contraction remarkably progresses over about 1000° C., and the change in the contraction coefficient to the change in temperature is up to about 8.54%/100° C. between 1000 to 1200° C.

Apparent from the graph in FIG. 4, in the region of 1000° C. or over in which the linear contraction coefficient remarkably changes to the change in temperature, remarkable variation in the linear contraction coefficient due to such as the dispersion of the temperature in the kiln upon calcining. Consequently, it is preferable to calcine in the region in which there is no such a tendency of change in order to restrain the dispersion of contraction upon calcining and to increase accuracy in dimensions after full burning. The tendency remarkably changes at 1000° C. or over, however, the linear contraction coefficient tends to increase over about 900° C. as described above, and since the change in the linear contraction coefficient between 900 and 1000° C. is 0.73%, the region in which the change can be regarded as sufficiently small is 950° C. or below. In the calcination temperature of 950° C. or below, the change of the linear contraction coefficient is only 0.53%.

Since the aforementioned disk-shaped calcined block 10 contracts in a slightly different manner from the aforementioned prism block, the result of the test for the flexural strength and the linear contraction coefficient is shown in Table 2 below. The mooring time upon calcining is three hours. The flexural strength was evaluated using the prism having the same dimensions as the aforementioned prism block that was cut away. In Table 2 the Diameters 1 and 2 were measured in two selected directions perpendicular to each other and the Thickness was measured in the center of the disk.

TABLE 2
Disk-shaped Block (Moored for three hours)

| | Flexural | | Sample 1 | | | Sample 2 | | | Sample 3 | | |
|---|---|---|---|---|---|---|---|---|---|---|---|
| Calcination | Strength | | BC | AC | LCC | BC | AC | LCC | BC | AC | LCC |
| Temperature | (MPa) | | (mm) | (mm) | (%) | (mm) | (mm) | (%) | (mm) | (mm) | (%) |
| 700° C. | 3.33 | Diameter 1 | 93.35 | 93.03 | 0.34 | | | | | | |
| | 2.64 | Diameter 2 | 93.39 | 93.06 | 0.35 | | | | | | |
| | 2.90 | Thickness | 14.28 | 14.24 | 0.28 | | | | | | |
| Average | 2.96 | | | | 0.33 | | | | | | |
| 800° C. | 6.69 | Diameter 1 | 93.56 | 93.12 | 0.47 | 93.45 | 93.03 | 0.45 | 93.27 | 92.89 | 0.41 |
| | 5.06 | Diameter 2 | 93.61 | 93.18 | 0.46 | 93.46 | 93.04 | 0.45 | 93.28 | 92.89 | 0.42 |
| | 5.11 | Thickness | 14.36 | 14.30 | 0.42 | 14.29 | 14.23 | 0.42 | 14.29 | 14.23 | 0.42 |
| Average | 5.62 | | | | 0.45 | | | 0.44 | | | 0.42 |
| 900° C. | 4.64 | Diameter 1 | 93.21 | 92.63 | 0.62 | 93.25 | 92.72 | 0.57 | | | |
| | 5.58 | Diameter 2 | 93.14 | 92.54 | 0.64 | 93.25 | 92.73 | 0.56 | | | |
| | 4.65 | Thickness | 14.23 | 14.15 | 0.56 | 14.24 | 14.16 | 0.56 | | | |
| Average | 4.96 | | | | 0.61 | | | 0.56 | | | |
| 950° C. | 14.37 | Diameter 1 | 93.56 | 92.68 | 0.94 | | | | | | |
| | 9.64 | Diameter 2 | 93.56 | 92.76 | 0.86 | | | | | | |
| | 18.67 | Thickness | 14.38 | 14.24 | 0.97 | | | | | | |
| Average | 14.23 | | | | 0.92 | | | | | | |
| 1050° C. | | Diameter 1 | 93.39 | 88.27 | 5.48 | 93.64 | 88.62 | 5.36 | | | |
| | | Diameter 2 | 93.40 | 88.45 | 5.30 | 93.65 | 88.69 | 5.30 | | | |
| | | Thickness | 14.28 | 13.53 | 5.27 | 14.37 | 13.60 | 5.34 | | | |
| Average | | | | | 5.35 | | | 5.33 | | | |

Notes:
BC: Before Calcination,
AC: After Calcination,
LCC: Linear Contraction Coefficient.

In the Table 2 above, since, in the case of the calcination temperature of 700° C., the flexural strength ranges from 2.64 to 3.33 MPa and 2.96 MPa in average, it is not sufficient in strength for such as cutting, also with the disk-shaped block. Since, in the case of 800° C., the flexural strength ranges from 5.06 to 6.69 MPa and 5.62 MPa in average, it is apparent that there is no problem in strength also with the disk-shaped block in the case of the calcination temperature of 800° C. or over.

On the other hand, since, in the case of 950° C., the linear contraction coefficient ranges from 0.86 to 0.97% and 0.92% in average, that is, it is within 1%, the dispersion of contraction is within tolerance. However, since, in the case of calcination at 1050° C., the linear contraction coefficient ranges from 5.27 to 5.48% and up to 5.35% in average for the Sample 1, and the linear contraction coefficient ranges from 5.30 to 5.36% and up to 5.33% in average for the Sample 2, it is not useful because the linear contraction coefficient is extremely large and the dispersion increases.

As described above, the linear contraction coefficient of the disk-shaped block is larger than that of the prism block. However, at or below the calcination temperature of 950° C., the linear contraction coefficient is to be below 1.0%. Consequently, the calcination temperature ranging from 800 to 950° C., at which it is sufficiently high in strength and the linear contraction coefficient is below 1.0% is requisite to obtain the calcined block 10 of which the accuracy in dimensions is sufficiently high.

The dispersions of the contraction coefficient in three axial directions in one sample are 0.05% in Sample 1, 0.03% in Sample 2 and 0.01% in Sample 3 in the case of the calcination temperature of 800° C., that is, all dispersions are within 0.05%. In the case of 900° C., the dispersions are 0.06% in Sample 1 and 0.01% in Sample 2, in the case of 950° C., the dispersion is 0.11%, and in the case of 1050° C., the dispersions are 0.18% in Sample 1 and 0.06% in Sample 2, and they are sufficiently small linear contraction coefficients, however, they exceed 0.05%. Consequently, the calcination temperature of 800° C. is most preferable for high accuracy of dimensions.

Table 3 below shows results of calcining at the calcination temperature of 800° C., with prism blocks having the same shape as those used in the test in Table 1 above, prepared from two kinds of zirconia materials A and B that are different from those used in the test in Table 1. The aforementioned two kinds of materials A and B are the TZP material in which 3 mol % yttrium oxide similar to that in Table 1 is added. In Table 3 the column of “No.” lists the sample numbers, “Theoretical Density Ratio” lists the ratio (%) of the density of the calcined body to 6.089 g/cm³, the theoretical density of the sintered body, and “Linear Contraction Coefficient” lists the contraction coefficients (%) in the length direction in the case of 77 mm of the formed dimension.

TABLE 3
Results of Calcination Test
Calcination Temperature: 800° C.
Shape of Samples: 77 × 23 × 18 mm

| | Material A | | Material B | |
|---|---|---|---|---|
| | Theoretical | Linear | Theoretical | Linear |
| | Density | Contraction | Density | Contraction |
| No. | Ratio (%) | Coefficient (%) | Ratio (%) | Coefficient (%) |
| 1 | 47.2 | 0.23 | 48.8 | 0.29 |
| 2 | 47.3 | 0.25 | 48.9 | 0.30 |
| 3 | 47.2 | 0.24 | 48.3 | 0.26 |
| 4 | 47.2 | 0.24 | 48.4 | 0.27 |
| 5 | 47.1 | 0.22 | 48.7 | 0.27 |
| 6 | 47.1 | 0.23 | 48.8 | 0.28 |
| Maximum | 47.3 | 0.25 | 48.9 | 0.30 |
| Minimum | 47.1 | 0.22 | 48.3 | 0.26 |
| Average | 47.2 | 0.24 | 48.7 | 0.28 |

As shown in Table 3 above, the theoretical density ratio ranges 47.1 to 47.3% and 47.2% in average, and the linear contraction coefficient ranges 0.22 to 0.25% and 0.24% in average, at the calcination temperature of 800° C., with the material A. And, with the material B, the theoretical density ratio ranges 48.3 to 48.9% and 48.7% in average, and the linear contraction coefficient ranges 0.26 to 0.30% and 0.28% in average. Considering the results in Table 1 above, although there are some differences both in the theoretical density ratio and the linear contraction coefficient that are considered to be derived from differences in the material, the theoretical density ratio is within the range from 47.1 to 48.9% and the linear contraction coefficient ranges 0.22 to 0.30%.

If the theoretical density ratio is at least within the range from 47 to 49%, then, the linear contraction coefficient is reduced to a sufficiently small value, that is, 1% or below, the dispersion of contraction reduced to an extremely small value, that is, below 0.5%, and, then, the dispersions of the contraction coefficient of each calcined body and of the linear contraction coefficient due to its position of individual calcined body

Above described in detail is the present invention with reference to the drawings. It is to be understood that the present invention may be embodied with other changes, improvements, and modifications that may occur to a person skilled in the art without departing from the scope and spirit of the invention defined in the appended claims.

1. A calcined ceramic body for dental use that is manufactured such that a formed body mainly containing zirconium oxide is worked in a degreasing process and in a calcining process, having:
a linear contraction coefficient upon full burning ranging from 19.0% to 22.0%.

2. A calcined ceramic body for dental use that is manufactured such that a formed body mainly containing zirconium oxide is worked in a degreasing process and in a calcining process, having:
a density ranging from 47% to 49% of a theoretical density of a sintered body.

3. The calcined ceramic body for dental use of claim 1, having a three-point bending strength ranging from 3 to 6 MPa.

4. The calcined ceramic body for dental use of claim 2, having a three-point bending strength ranging from 3 to 6 MPa.

5. The calcined ceramic body for dental use of claim 1, of which a calcination temperature ranges from 800° C. to 950° C.

6. The calcined ceramic body for dental use of claim 2, of which a calcination temperature ranges from 800° C. to 950° C.

7. The calcined ceramic body for dental use of claim 1, which includes 91.00 to 98.45 wt % zirconium oxide, 1.5 to 6.0 wt % yttrium oxide, and 0.05 to 0.50 wt % oxide or oxides of at least one of aluminum, gallium, germanium and indium.

8. The calcined ceramic body for dental use of claim 2, which includes 91.00 to 98.45 wt % zirconium oxide, 1.5 to 6.0 wt % yttrium oxide, and 0.05 to 0.50 wt % oxide or oxides of at least one of aluminum, gallium, germanium and indium.

9. The calcined ceramic body for dental use of claim 1, which includes a pigment.

10. The calcined ceramic body for dental use of claim 2, which includes a pigment.

11. The calcined ceramic body for dental use of claim 1, wherein the formed body is made by pressing zirconia material granules, and the formed body is worked in a calcining process after it is formed in cold isostatic pressing (CIP).

12. The calcined ceramic body for dental use of claim 2, wherein the formed body is made by pressing zirconia material granules, and the formed body is worked in a calcining process after it is formed in cold isostatic pressing (CIP).

13. The calcined ceramic body for dental use of claim 11, which is used for manufacturing an artificial tooth which is manufactured by cutting off a frame calcined body by cutting the calcined body using CAM in accordance with a drawing of a frame previously prepared, by burning the frame calcined body to obtain a sintered frame, and by piling a porcelain material on a surface of the frame.

14. The calcined ceramic body for dental use of claim 12, which is used for manufacturing an artificial tooth which is manufactured by cutting off a frame calcined body by cutting the calcined body using CAM in accordance with a drawing of a frame previously prepared, by burning the frame calcined body to obtain a sintered frame, and by piling a porcelain material on a surface of the frame.
